(19) United States
(12) Patent Application Publication
(10) Pub. No.: US 2006/0277415 A1
(43) Pub. Date: Dec. 7, 2006

(54) Content protection method and system

(76) Inventors: Antonius Adriaan Maria Staring, Eindhoven (NL); Johan Cornelis Talstra, Eindhoven (NL); Boris Skoric, Eindhoven (NL); Maurice Jerome Justin Jean Baptiste Maes, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/570,542

(22) PCT Filed: Aug. 27, 2004
(86) PCT No.: PCT/IB04/51585

§ 371 Date: Mar. 3, 2006

(30) Foreign Application Priority Data
Sep. 10, 2003 (EP) 03103342.6

(51) Int. Cl. H04L 9/32; H04L 9/00; G06F 12/14; G06F 17/30; G06F 7/04; G06F 11/30; G06K 9/00; H03M 1/68; H04K 1/00; H04N 7/16

(52) U.S. Cl. 713/193; 713/181; 726/27

(57) ABSTRACT

The present invention relates to a content protection method and system as well as to a reproduction method and device providing copy protection of electronic content. In order to provide protection against illicit copying by consumers as well as by authoring and formatting facilities content-dependent encryption of the content is proposed. In an encryption step the content (C0) is encrypted using an application key (AK) and/or a disc key (DK). Further, a content-dependent content mark (AK′, H, MAC) is generated using said content (C0), which content mark is to be evaluated during decryption of said encrypted content (C2).

The present invention relates to a content protection method and a corresponding system providing copy protection of electronic content, such as audio, video, software or any other kind of information, which is stored on a storage medium such as a record carrier or transmitted via a transmission line. Further, the present invention relates to a reproduction method and device for reproducing electronic content which is encrypted. Still further, the present invention relates to a record carrier and a signal providing copy protection of electronic content as well as to a computer program for implementing the content protection method and the reproduction method according to the invention.

Optical discs have proven to be excellent removable storage media for (audio-visual) content. With the increasing storage capacity of optical discs, from the 650 MB CD-R(W) disc to the 25 GB Blu-Ray disc and beyond, the use of such discs develops along two lines. Along the first line, higher quality content is stored on the disc, e.g. Super Audio CD quality versus CD Digital Audio quality, or High-Definition Video versus Standard Definition Video. Along the second line, multiple unrelated applications share one and the same disc, e.g. audio, video, and games applications.

An issue with the first line is that because of the higher value of the content, content owners put even more emphasis on the need for strong content protection systems than currently is the case for standard quality content. In addition, content owners not only require that the content protection system protects against illicit copying by consumers, but preferably also discourages pirate authoring and formatting facilities.

An issue with the second line is that if applications share the same content protection system, which is provided by the optical disc, all applications are equally vulnerable to hacking of that content protection system. It is therefore desirable to design the content protection system in such a way that hacking of one application does not affect other applications. However, the design is subject to the restriction that for reasons of cost efficiency it is not allowed to design completely independent content protection systems for all applications that share a disc. Another reason for this restriction is that it is not a priori known which and how many applications will share a disc.

It is thus an object of the present invention to provide a content protection method and system as well as a reproduction method and device by which the above described problems are solved, which provide a strong content protection against copying and which avoid that hacking of one application does affect other applications as well. Further, a corresponding record carrier and signal and a computer program for implementing said methods shall be provided.

This object is achieved according to the present invention by a content protection method as claimed in claim 1.

A corresponding content protection system comprising a first content encryption unit, a second content encryption unit and a mark generation unit is defined in claim 10.

The present invention is based on the idea to use content-dependent encryption of the content. In an encryption step the original content is at least once encrypted using an application key and/or a disc key. In addition a content-dependent content mark is generated that needs to be evaluated and checked during decryption and reproduction of said encrypted content. By use of said content-dependent content mark it is easily detectable during decryption if the content or any keys have been hacked. For instance, it can be prevented that authoring and formatting facilities conspire to circumvent content protection systems, for example by replacing part or all of the original content by illicit content.

Preferred embodiments of the invention are defined in the dependent claims. According to a preferred embodiment double encryption of the content is provided. A first content encryption unit, for instance an authoring facility for authoring the original content, encrypts the content using a first key (the application key) at the application level, possibly taking the content structure into account. A second content encryption unit, for instance a formatting facility for formatting said authored content, encrypts the once encrypted content using a second key (the disc key) at the disc level, e.g. taking only sectors and other disc format specific structures into account.

The double encryption approach according to the invention, which may also be used independently from the use of a content-dependent mark, solves the above described first problem if the keys that the first and second content encryption unit use are independent. The second problem is solved if a reproduction device, such as a drive, does not output the application key to an application of the wrong type. This can be avoided by requiring the drive and an application to communicate through a secure authenticated channel (SAC). Such a channel forces the application to authenticate itself to the drive as being of a specific type. For example, if an audio application requests the application level key of content of a video application, the drive will refuse the request. Thus, potential hacking of the audio application does not harm the video application.

In other words, the authoring/formatting stage of content publishing is secured using double encryption plus the services of a trusted third party and content hashing to provide a reproduction device either information based or decision based access to the application decryption key. Further, secure multiple independent applications that use the same record carrier from each other are secured using double encryption plus a secure authenticated channel with application identification to provide decision based access to the application key.

A complication is that the first content encryption unit must use the authoring facility to communicate the application key to the application. The solution is to employ the services of a mark generation unit, such as a trusted third party, e.g. the system licensor, as an intermediary which, according to a preferred embodiment, not only generates the content-dependent content mark, which is thus not known to the first and second encryption unit, but also encrypts the application key. The function of the mark generation unit, i.e. the trusted third party, is twofold: It verifies the trustworthiness of the first encryption unit (authoring facility), and it provides the, preferably encrypted application key to the second encryption unit (formatting facility).

According to another embodiment of the method a third encryption step is provided encrypting said application key using said content, said encrypted application key representing said content mark. This third encryption step is preferably done in said mark generation unit (trusted third party) so that neither the first nor the second encryption unit know how the application key is encrypted in order to prevent that said first and second encryption unit conspire to circumvent this protection mechanism. Since according to this embodiment the content is used for encryption of the application key hacking of this encryption key only enables the hacker to retrieve this particular application key, but can not be used for hacking of different application keys or hacking of a different content. A decryption unit in a read-out device will immediately detect if an encryption key required for decryption of the application key does not belong to said application key and/or to the corresponding content.

According to another embodiment a step of generating a hash of at least parts of the content is provided, said hash representing the content mark. This hash needs then to be available to a reproduction device along with the content. During reproduction a corresponding hash will be reproduced from said content and compared against the hash provided along with the content. If they match the content is still the original content; if not, the content is probably pirated. Again, it is preferred that the way of generating the hash from the content is neither known to the first nor to the second encryption unit.

In order to further increase the level of security the disc key and the application key are also encrypted into application key data using a key block key according to a preferred embodiment, which key block key is preferably encoded into a key block or a key locker. These application key data and this key block key or said key block/key locker will be required by a reproduction device for retrieving the disc key and the application key.

According to still another embodiment a hashing step is provided for generating hash information using said content for use by a reproduction device for decrypting said application key and/or for comparing to hash information reproduced by a reproduction device from said content. Such hash information may comprise address information indicating parts of the content based on which the application key has been encrypted and/or offset information indicating an offset address from the start of the content and a length information indicating the length of content from said offset address. For each application key a corresponding offset information and a corresponding length information is provided. During reproduction the corresponding hash information needs then to be reproduced from the content using said address information in order to be able to decrypt the application key and thus finally in order to be able to decrypt the encrypted content. If parts or all of the content has been replaced by a different content or if old keys have been used during authoring or mastering, the content will not be reproducible since content and keys do not belong together.

To obtain the disc key corresponding disc key data will be provided from the mark generation unit to the second content encryption unit in which the disc key is encrypted so that only the second encryption unit can decrypt and use the disc key.

Furthermore, it is advantageous that a content identifier is used to ensure that only authorized or trusted units retrieve data or keys for encryption of the content. Thus, a content owner may issue a content identifier and provide it to the mark generation unit and the first and/or second encryption unit. The encryption units then will need to send this content identifier to each other and/or to the mark generation unit in order to show their authorization and to receive data and/or keys for encryption. In addition, an authoring identifier may be used which is issued from the content owner and provided to the mark generation unit. Only if the first encryption unit can identify to the mark generation unit by use of the combination of the content identifier and the authoring identifier protection is secured. Preferred embodiments of the use of the content and/or authoring identifier are defined in dependent claims 13 to 16.

The present invention also relates to a reproduction method and a corresponding reproduction device as defined in claim 17.

Preferred embodiment of the reproduction method and device are defined in dependent claims. Preferably, two content decryption units are provided, the first content decryption unit being included in a drive unit for reading data from a record or a receiver unit for receiving data from a transmission line, and said second content decryption unit being included in an application unit for running an application, both said drive unit and said application unit being functional units of a computer and being preferably connected by a secure authenticated channel.

The present invention relates also to a record carrier as well as to a signal providing copy protection of electronic content comprising:

encrypted electronic content, an encryption being made using an application key and/or a disc key,

a content-dependent content mark generated using said content, said content mark being to be evaluated during decryption of said encrypted content,

said disc key and/or said application key.

The copy protection method and the reproduction method according to the present invention can be implemented on a computer by a computer program comprising program code means for causing a computer to carry out the steps of the methods when said computer program is executed on a computer.

The invention will now be defined in more detail with reference to the drawings in which

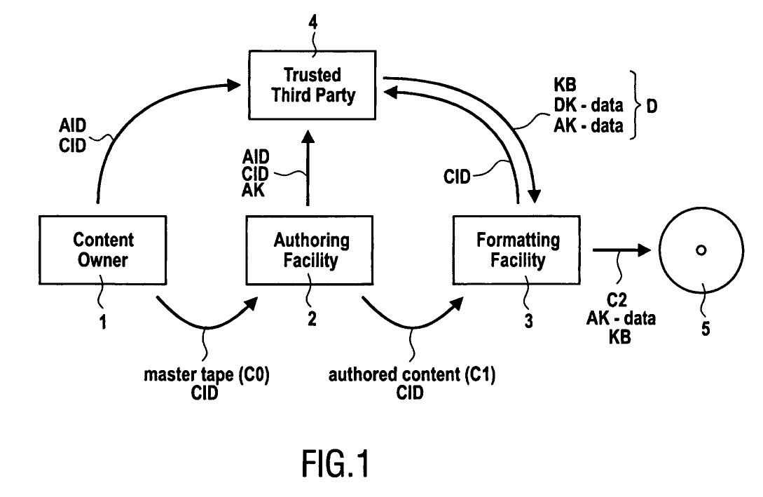

FIG. 1 shows a block diagram of a copy protection system according to the invention,

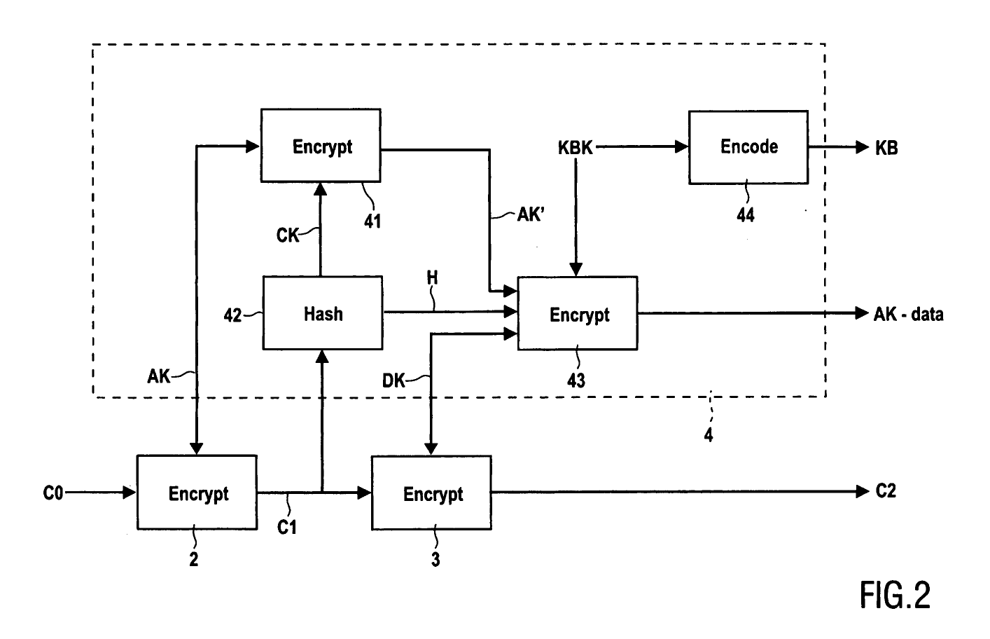

FIG. 2 shows a block diagram illustrating the steps of a copy protection method according to the invention,

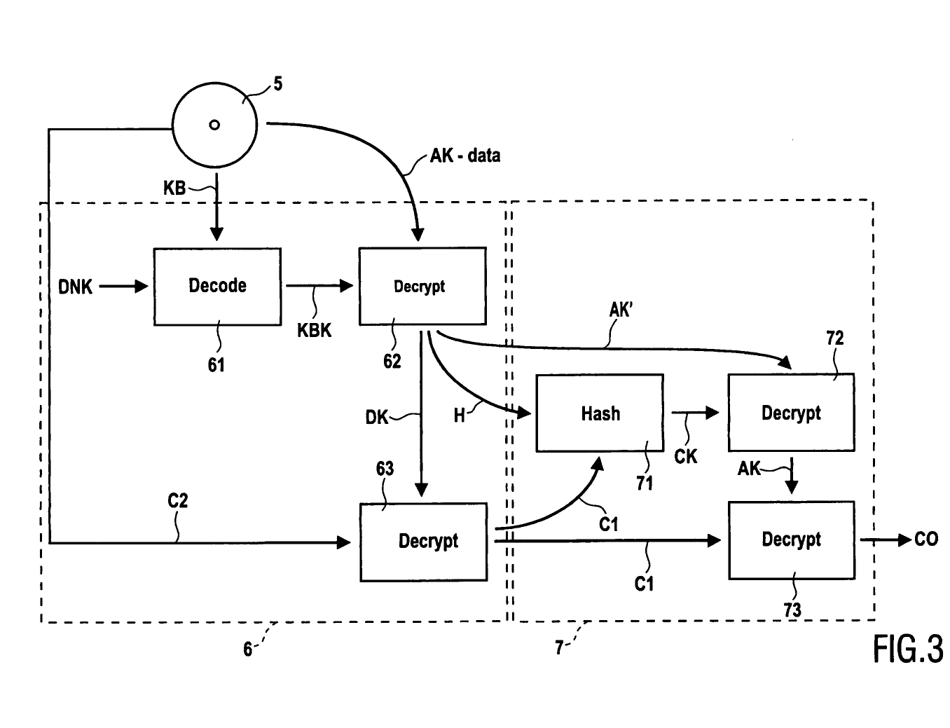

FIG. 3 shows a block diagram of a reproduction method according to the invention,

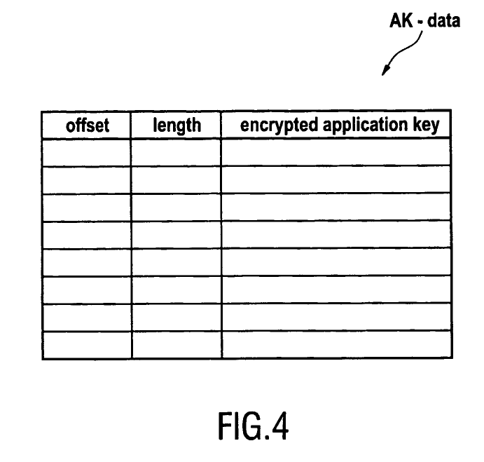

FIG. 4 shows an example of application key data,

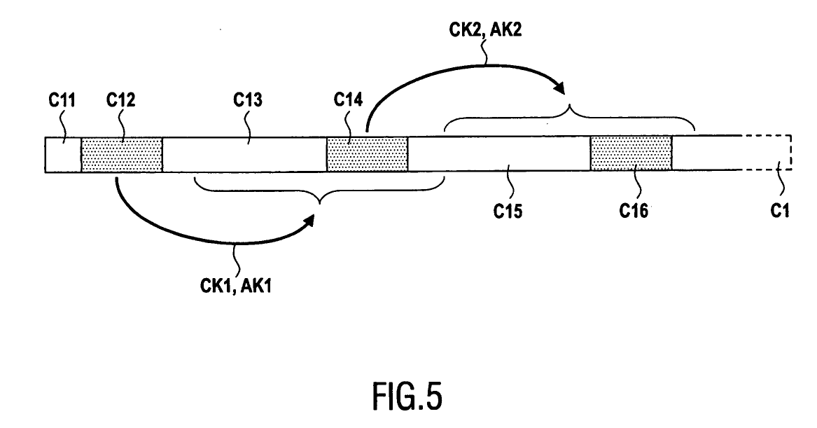

FIG. 5 illustrates application level content encryption,

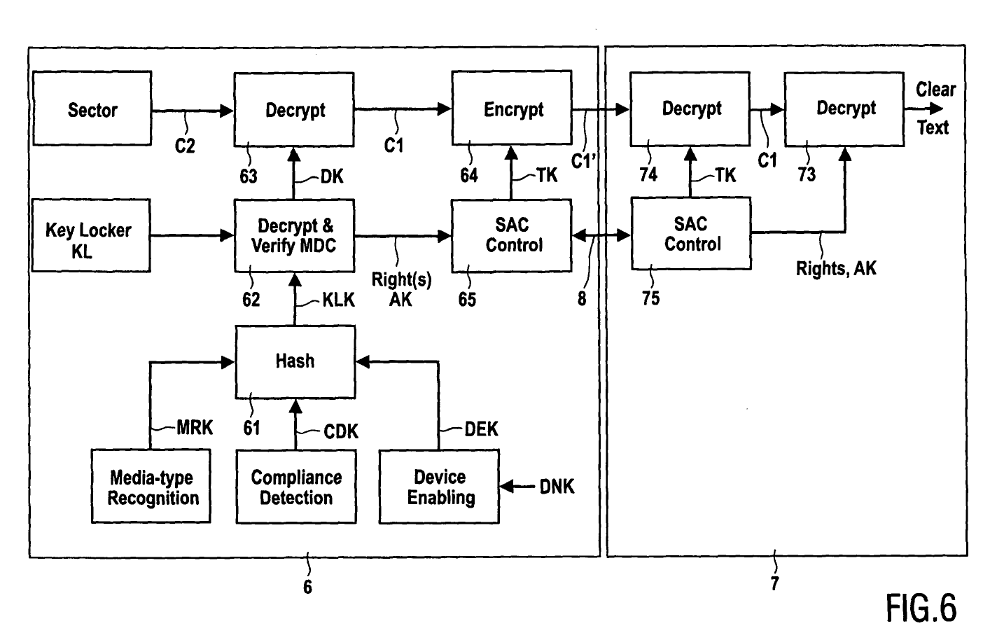

FIG. 6 shows another embodiment of a reproduction method according to the invention,

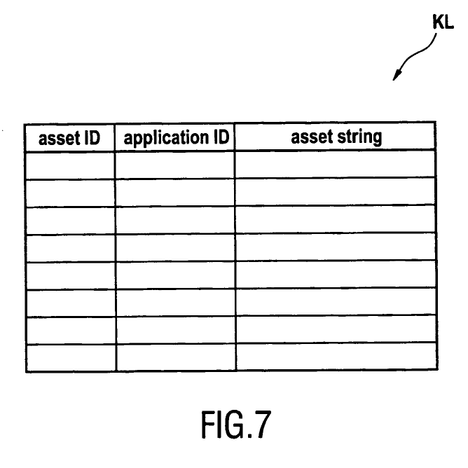

FIG. 7 shows an example of a key locker and

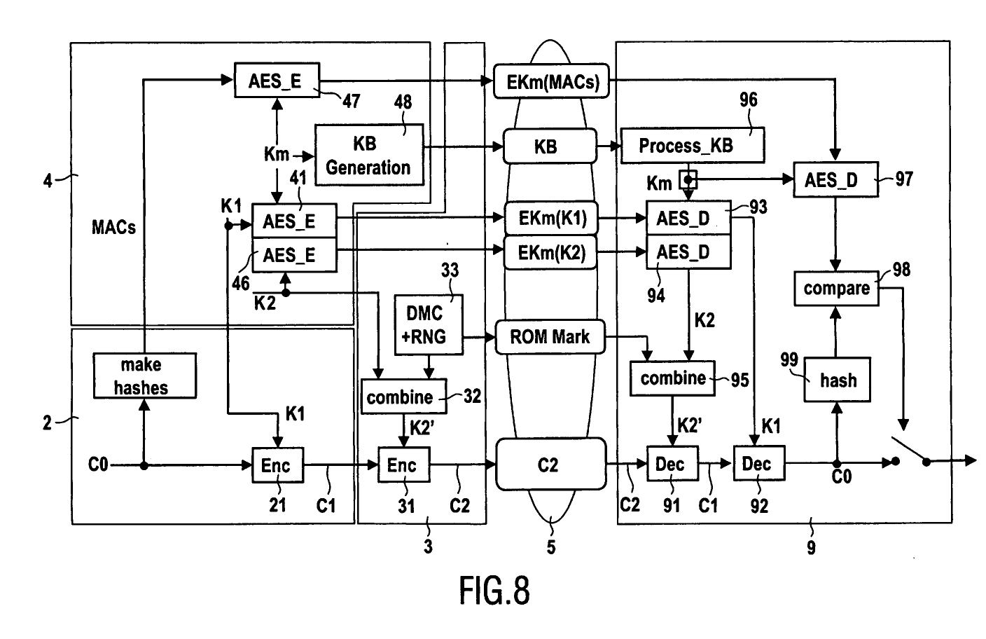

FIG. 8 illustrates another embodiment of a copy protection method according to the invention.

FIG. 1 shows a block diagram of an embodiment of a content protection system according to the invention. Therein it is illustrated how double encryption of content provides control over both authoring and formatting facilities in the process of production of a record carrier, such as a disc, on which the content shall be stored. FIG. 1 shows the parties involved in disc production as well as the data flow between those parties.

As shown in FIG. 1, there are four parties involved in disc production, namely a Content Owner 1, an Authoring Facility 2, also called first encryption unit, a Formatting Facility 3, also called second encryption unit, and a Trusted Third Party 4, also called mark generation unit. Each Authoring Facility 2 must have a license. A licensed Authoring Facility 2 has a unique authoring identifier AID. The Trusted Third Party 4 manages the system security. All communications between the Trusted Third Party 4 and the Content Owner 1 as well as the Authoring Facility 2 take place through a Secure Authenticated Channel.

The Content Owner 1 initiates the process by sending the Trusted Third Party 4 a unique content identifier CID as well as the authoring identifier AID of an Authoring Facility 2. Next, the Content Owner 1 sends a master tape containing the “raw” content C0 to the designated Authoring Facility 2. The Content Owner 1 includes the content identifier CID with the master tape. When the Authoring Facility 2 finishes its job, it sends the Trusted Third Party 4 its authoring identifier AID, the content identifier CID, and the application key(s) AK that were used to encrypt the authored content. The Trusted Third Party 4 does not accept the data from the Authoring Facility 2 if it has not previously received the corresponding authoring identifier/content identifier AID/CID combination from the Content Owner 1. Alternatively (or in addition), the Trusted Third Party 4 may alarm the Content Owner 1 if it receives an incorrect combination authoring identifier/content identifier AID/CID. Yet another action of the Trusted Third Party 4 may be to inform the Content Owner 1 if a content identifier CID is used more than once.

Next, the Authoring Facility 2 sends the once encrypted, authored content C1 and the content identifier CID to a Formatting Facility 3. The Formatting Facility 3 sends the content identifier CID to the Trusted Third Party 4 to request decryption data D. The decryption data D consist of a key block KB, disc key data DK-data, and application key data AK-data. Only authorized playback devices can decode the key block KB. The Formatting Facility 3 cannot decode the key block KB. Decoding of the key block KB yields the key block key KBK. The disc key data DK-data consist of the disc key DK, encrypted for use by the requesting Formatting Facility 3 only. The application key data AK-data contain the disc key DK, application key(s) AK and other decryption data for use by a playback device. The application key data AK-data is encrypted using the key block key KBK. The Trusted Third Party 4 may inform the Content Owner 1 of the Formatting Facility's 3 request, and ask for approval to return the decryption data. The Formatting Facility uses the decryption data D to format the authored content C1 on the disc 5. In this process, the Formatting Facility 3 uses the disc key DK to encrypt the (already once encrypted) authored content C1 resulting in twice encrypted content C2, which is then stored on the disc 5 together with the application key data AK-data and the key block KB. Instead of storing the twice encrypted content C along with the application key data AK-data and the key block KB on a disc 5 it can also be transmitted over a transmission line, such as the internet, or stored on a different storage medium, such as a harddisk.

FIG. 2 illustrates in more detail the steps used in the embodiment of the copy protection system as shown in FIG. 1 for encryption of the content C0 and the different keys. Besides encryption of the original content C0 in two steps by encryption units 2 and 3 resulting in the twice encrypted content C2, a content key CK is generated from the once encrypted content C1 (or alternatively from the original content C1) in a hashing unit 42 of the mark generation unit 4 (trusted third party). Using this content key CK the application key(s) AK used for encryption of the original content C0 are encrypted in an encryption unit 41 to obtain encrypted application key(s) AK′. Further, the hashing unit 42 randomly generates hash information H. This hash information H, the encrypted application key(s) AK′ and the disc key DK used for encryption of the once encrypted content C1 are encrypted into application key data AK-data in a further encryption unit 43 by use of a key block key KBK. The key block key KBK itself is encoded into a key block KB by an encoder 44. It should be noted that in general there are many ways to constructing the key with which to encrypt the content and that the above just gives one example.

As shown in FIG. 3, the twice encrypted content C2 is decrypted in two stages, in this example within a PC comprising a drive 6 and an application 7. In the first stage, the drive 6 uses the disc key DK. In the second stage, the application 7 uses the application key(s) AK. The drive 6 and application 7 are different functional units in the playback device. In a PC type environment the application 7 may consist of software running on the host processor. The drive 6 starts decryption of the content by decoding the key block KB read from the disc 5 using its device keys DNK (often also called device node keys) within a decoder unit 61. Next, the drive 6 uses the key block key KBK to decrypt the application key data AK-data read from the disc 5 in a decryption unit 62. This yields the disc key DK, which the drive 6 uses for the first stage decryption of the content C2 in a content decryption unit 63. Decryption of the application key data AK-data also yields the encrypted application key(s) AK and hash information H. If necessary, e.g. in a PC type environment, the drive 6 sends this data to the application 7 through a Secure Authenticated Channel (not shown).

The application 7 computes the content key CK that is required to decrypt the application key(s) AK using the hash information H in a hashing unit 71, which will be explained in more detail below, in combination with the content C1, which is still once encrypted using the application key(s) AK. Finally, the application 7 decrypts the encrypted application key(s) AK in a key decryption unit 72 by use of the content key CK and uses the decrypted application key(s) AK for second stage decryption of the content C1 in a further content decryption unit 73 resulting finally in the original content C0.

The reason that the application key data contain encrypted application key(s), where the encryption key depends on the content is to prevent that the Authoring Facility and the Formatting Facility can conspire to circumvent this protection mechanism. If content-dependent encryption of the application key(s) would not be used, an Authoring Facility might provide a Formatting Facility with illicitly authored content that re-uses application key(s) for which the Formatting Facility already has the correct application key data.

FIG. 4 shows an example of the application key data AK-data (it is to be noted that the disc key DK has been omitted). It consists of a table of multiple entries, where the first column contains an offset into the content, the second column specifies an amount of content, and the third column contains an encrypted application key AK.

FIG. 5 shows how the application key(s) AK contained in the application key data AK-data can be used efficiently. The shaded areas represent the parts of the content C1 that are specified by the offset/length fields in the application key data AK-data. The first part C11+C12 of the content C1 containing the first shaded area C12 is not encrypted with an application key AK, which means that the application can start playing immediately. While playing, the application calculates a hash H of the shaded area C12 to obtain the (first) content key CK1 and uses the result (i.e. the content key CK1) to decrypt the corresponding (first) application key AK1. The application uses that application key AK1 to decrypt the next part C13+C14 of the content, as indicated by the first curly brace. While playing this part C13+C14 of the content, the application calculates the hash H of the second shaded area C14. It is recommended to calculate the hash prior to decryption with the application key. Otherwise, random access to the content would become very difficult. Next, the application uses the hash result (i.e. the next content key CK2) to decrypt the second application key AK2, and uses that key AK2 to decrypt the third segment C15+C16 of the content. This process repeats till the end of the content.

FIG. 6 shows another embodiment of reproduction device according to the present invention using a key hierarchy that uses double encryption and a Secure Authenticated Channel to isolate different application types from each other. In addition to copy protection, it may also provide applications with facilities that are required to implement Digital Rights Management systems. Central to the key hierarchy shown in FIG. 6 is the key locker KL, which stores application keys and usage rights in an application-specific format. In addition, the key locker stores a disc key, which is used to encrypt content that is stored on the disc. These keys and rights can be accessed after decryption of the key locker KL using the key locker key KLK in the key decryption unit 62. The key locker key KLK is obtained by the hashing unit 61 from a media recognition key MRK, a compliance detection key CDK and a device enabling key DEK obtained from the device keys DNK in this example.

Prior to transferring content to the application 7, the drive 6 decrypts sector data (i.e. content) using the disc key DK (i.e. first stage decryption) in the decryption unit 63 and subsequently re-encrypts the sector data C1 using a temporary key TK in a re-encryption unit 64.

The application 7 obtains this temporary key TK from the drive 6 through a Secure Authenticated Channel 8 controlled by SAC control units 65, 75. In addition to the temporary key TK, the application 7obtains the application key(s) AK and usage rights (if any) through this channel 8. The application 7 first decrypts the re-encrypted content C1′ using the temporary key TK in a decryption unit 74 and subsequently decrypts the content C1 using the application key AK (i.e. second stage decryption) in decryption unit 73.

It should be noted that an application 7 can only obtain the application key AK through the Secure Authenticated Channel 8 if it is authorized for that key. This is enforced by specific information in the key locker as will be explained below. As a result, different types of applications are effectively isolated from each other: If one application type is broken, it still cannot access the application key(s) of other application types.

FIG. 7 shows an example of the key locker format. Basically, it is a table that consists of three columns. A row in this table is called an asset. The first column contains the asset identifier (asset ID), which identifies the asset. The second column contains the application identifier (application ID). A drive uses the value in this field to determine if an application is authorized to access the asset: An application identifies itself using an application ID while establishing a Secure Authenticated Channel. The drive prevents the application to access assets that contain a different application ID. Finally, the third column contains an asset string. The asset string has an application-specific format, and contains e.g. the application key and usage rights, or application key data as described above.

FIG. 8 shows another embodiment of a content protection system according to the present invention comprising an authoring site 2, a disc manufacturer 3, a key issuing center 4 and a disc player 9. Also in this embodiment the original content C0 is twice encrypted, once by a first encryption unit 21 using a first encryption key K1 at the authoring site 2 and a second time by a second encryption unit 31 using a second encryption key K2′ at the disc manufacturer before the twice encrypted content C2 is stored on the record carrier 5. In the player the same keys K2′ and K1 are used to decrypt the twice encrypted content C2 by decryption units 91, 92 to retrieve the original content C0.

The first encryption key K1 is provided by the key issuing center 4 which also encrypts this key by a key encryption unit 41 for storage on the record carrier 5 through the disc manufacturer 3. The second encryption key K2′ is generated by the disc manufacturer 3 in a combination unit 32 by combining an encryption key K2 also provided by the key issuing center 4 and a ROM mark generated by a ROM mark generation unit 33. Original key K2 is also encrypted by the key issuing center 4 in an encryption unit 46 for storage on the record carrier 5 through the disc manufacturer 3. Further, also the ROM mark generated by the disc manufacturer 3 is provided on the record carrier S. Within the player 9 the encrypted keys K1 and K2 both stored on the record carrier 5 are decrypted by decryption units 93, 94. Further, the decrypted key K2 is combined with the ROM mark by a combination unit 95 to retrieve the decryption key K2′.

In order to prevent a professional piracy scenario according to which the authoring site 2 and the disc manufacturer 3 conspire together to get an illegal master tape and to re-use keys from previous works for encryption of new content, a content-dependent check is provided during playback according to the invention. Therefore, the authoring site 2 computes hashes of the original content C0 by a hashing unit 22. The content C0 is thus divided into large blocks, and for each block a message authentication code (MAC) is generated. These MACs are encrypted by an encryption unit 47 within the key issuing center 4 and are also stored on the record carrier 5. For encryption of the MACs as well as for encryption of the keys K1, K2 another key Km is used by the key issuing center 4 which is unknown to the authoring site 2 and the disc manufacturer 3. By a key block generation unit 48 a key block KB is generated which is also stored on the record carrier 5 and will be processed by the player 9 in a processing unit 96 to retrieve the key Km.

In the player 9 the encrypted MACs are read from the record carrier 5 and decrypted by a decryption unit 97 using the retrieved key Km. To check if the already decrypted content C0 is still the original content the obtained MACs are compared by a comparison unit 98 against MACs generated by the player 9 from the decrypted content C0 using a hashing unit 99. If the MACs match, the player 9 is still playing the original content; if not, there is a high probability that the content has been pirated.

In order to avoid that too much of storage is required on the record carrier 5 for storage of the MACs they should be computed over quite large blocks of content, e.g. 100 MB. This also reduces the number of checks to be required in the player 9. Further, it is preferred that a MAC is only checked after the player reads one block contiguously. This avoids a large overhead in the player and delays during playback. Preferably, during random excess the MAC is not checked. The MAC itself can be stored in a separate table or can be multiplexed into the logical format of other data.

The present invention provides a solution against illicit copying by consumers as well as against illicit pirating by authoring and formatting facilities. Further, a hacking of one application does not effect other applications. In an encryption step the content is encrypted using an application key, which is preferably content-dependent, and/or a disc key, preferably taking only sector and other disc format specific structures into account. Further, a content-dependent content mark is generated using said content, which content mark is to be evaluated during decryption of said encrypted content.

1. Content protection method providing copy protection of electronic content comprising:
an encryption step encrypting the content (C0) using an application key (AK) and/or a disc key (DK), and
a generation step for generating a content-dependent content mark (AK′, H, MAC) using said content (C0, C1) to be evaluated during decryption of said encrypted content (C2).

2. Content protection method as claimed in claim 1, wherein in a first encryption step the original content (C0) is encrypted using said application key (AK) and in a second encryption step the once encrypted content (C1) is encrypted using said disc key (DK).

3. Content protection method as claimed in claim 1, wherein said generation step comprises a third encryption step encrypting said application key (AK) using said content (C0, C1), said encrypted application key representing said content mark.

4. Content protection method as claimed in claim 1, wherein said generation step comprises a step of generating a hash (H) of at least parts of the content (C0, C1), said hash (H) representing said content mark.

5. Content protection method as claimed in claim 1, further comprising a fourth encryption step encrypting said disc key (DK) and said application key (AK, AK′) into application key data (AK-data) using a key block key.

6. Content protection method as claimed in claim 5, wherein said key block key (KBK) is encoded into a key block (KB) or a key locker (KL).

7. Content protection method as claimed in claim 1, further comprising a hashing step generating hash information (H, MAC) using said content (C0, C1) for use by a reproduction device for decrypting said application key (AK) and/or for comparing to hash information reproduced by a reproduction device from said content (C0, C1).

8. Content protection method as claimed in claim 7, wherein said hash information (H) comprises address information indicating parts of said content (C1) based on which said application key (AK) has been encrypted.

9. Content protection method as claimed in claim 8, wherein said address information comprises an offset information indicating an offset address from the start of said content (C1) and a length information indicating the length of content from said offset address, each application key (AK) having a corresponding offset information and a corresponding length information.

10. Content protection system providing copy protection of electronic content comprising:
a content encryption unit (2, 3) for encrypting the content (C0) using an application key (AK) and/or a disc key (DK), and
a mark generation unit (4) for generating a content-dependent content mark (AK′, H, MAC) using said content (C0, C1) to be evaluated during decryption of said encrypted content (C2).

11. Content protection system as claimed in claim 10, comprising a first encryption unit (2) for encrypting the original content (C0) using an application key (AK) and a second encryption unit (3) for encrypting the once encrypted content (C1) using a disc key (DK), wherein said first content encryption unit (2) is an authoring facility for authoring said original content (C0), said second content encryption unit (3) is a formatting facility for formatting said authored content (C1) and said mark generation unit (4) is a trusted third party for issuing and checking keys.

12. Content protection system as claimed in claim 11, wherein said second content encryption unit (3) is adapted for decrypting disc key data (DK-data) received from said mark generation unit (4) to obtain said disc key (DK).

13. Content protection system as claimed in claim 12, wherein said second content encryption unit (3) is adapted for requesting said disc key data (DK-data) from said mark generation unit (4) based on a content identifier (CID) received from said first content encryption unit (2).

14. Content protection system as claimed in claim 13, wherein said mark generation unit (4) is adapted for authenticating said first content encryption unit (2) based on said content identifier (CID) received from said first content encryption unit (2) and from a content owner (1).

15. Content protection system as claimed in claim 14, wherein said mark generation unit (4) is adapted for further using an authoring identifier (AID) received from said first content encryption unit (2) and from said content owner (1) for authenticating said first content encryption unit (2).

16. Content protection system as claimed in claim 15, wherein said mark generation unit (4) is adapted for informing said content owner (1) if an incorrect content identifier (CID) and/or authoring identifier (AID) and/or if an already used content identifier (CID) has been received from said first content encryption unit (2).

17. Reproduction method for reproducing electronic content (C2) encrypted for copy protection using an application key (AK) and/or a disc key (DK) and a content-dependent content mark (AK′, H, MAC) comprising:
a decryption step decrypting the encrypted content (C2) using said disc key (DK) and/or said application key (AK), and
a checking step for evaluating and/or checking said content mark (AK′, H, MAC).

18. Reproduction method as claimed in claim 17, wherein said checking step comprises the step of decrypting said application key (AK) using said content (C0), said encrypted application key (AK′) representing said content mark.

19. Reproduction method as claimed in claim 17, wherein said checking step comprises the step of generating a hash (MAC) of at least parts of the decrypted content (C0) and comparing said hash (MAC) with said content mark.

20. Reproduction device for reproducing electronic content (C2) encrypted for copy protection using an application key (AK) and/or a disc key (DK) and a content-dependent content mark (AK′, H, MAC) comprising:
a content decryption unit for decrypting the encrypted content (C2) using said disc key (DK) and/or said application key (AK), and
a checking unit (71, 72, 98) for evaluating and/or checking said content mark (AK′, H, MAC).

21. Record carrier providing copy protection of electronic content comprising:
encrypted electronic content (C2), an encryption being made using an application key (AK) and/or a disc key (DK),
a content-dependent content mark (AK′, H, MAC) generated using said content (C0), said content mark being evaluated during decryption of said encrypted content (C2), and
said disc key (DK) and/or said application key (AK).

22. Signal providing copy protection of electronic content comprising:
encrypted electronic content (C2), an encryption being made using an application key (AK) and/or a disc key (DK),
a content-dependent content mark (AK′, H, MAC) generated using said content (C0), said content mark being evaluated during decryption of said encrypted content (C2), and
said disc key (DK) and/or said application key (AK).

23. Computer program comprising program code means for causing a computer to carry out the steps of the methods as claimed in 1 when said computer program is executed on a computer.
